(19) United States
(12) Patent Application Publication
(10) Pub. No.: US 2018/0196797 A1
(43) Pub. Date: Jul. 12, 2018

(54) SCHEME FOR RECOGNIZING AND EVALUATING MATH CONTENT WITHIN TEXT IN DOCUMENTS AND WEB APPLICATIONS

(71) Applicants: Marwan Monzer Mansour, Beirut (LB); Mohammad Monzer Mansour, San Jose, CA (US)

(72) Inventors: Marwan Monzer Mansour, Beirut (LB); Mohammad Monzer Mansour, San Jose, CA (US)

(21) Appl. No.: 15/400,911

(22) Filed: Jan. 6, 2017

(51) Int. Cl. G06F 17/27; G06F 17/24

(52) U.S. Cl. CPC G06F 17/2725; G06F 17/24; G06F 17/273; G06F 17/271

(57) ABSTRACT

A math tool for recognizing and evaluating mathematical content within text in text processing applications and web applications is disclosed. The tool automatically recognizes user input and identifies mathematical content (expressions including basic operators, constants, variables, in-built and user defined functions, units, currencies, date-time, complex numbers, vectors, matrixes, tables, plots and other mathematical notations) for the purpose of validation (auto spell check), evaluating (auto evaluating/solving), formatting and plotting (line plots of functions, vectors; pie charts/bar graphs of data, 3D plots for multivariable functions, etc.) if required in a seamless fashion without (or with minimal) user intervention.

### BACKGROUND OF THE DISCLOSURE

### Field of the Disclosure

Embodiments of the present disclosure generally relate to productivity software and more specifically relate to mathematical tools (math tools) to evaluate and check mathematical expressions and visualize numeric data/symbolic functions in the form of various plots/tables within standard word/text processing applications, like Microsoft Office™ suite, simple text editing applications, web email, social media, online document editing applications, etc.

### Description of the Related Art

Conventional text processing tools do not recognize math syntax and are agnostic to mathematical content. For users who write documents with math content, this is inconvenient and counter-productive because automatic spell-checkers do not recognize and cannot verify math equations. Hence, the user needs to manually check calculations, track variables, equations/functions, and units while proofreading. Existing spell checkers provide grammatical and vocabulary checks on user input. However, they are incapable of recognizing or interpreting mathematical content. The only way for the user to validate their math expressions is to manually check them, or use specialized external software. This is a very tedious process and prone to errors, especially in technical and scientific documents with rich mathematical content. Existing word processing tools/email or other web applications do not provide an easy way to solve symbolic functions, generate numeric data and then visualize them in the form of plots and tables. A typical technical article (document, presentation, email, web blog, etc.) embodies textual description, numeric data, and mathematical expressions. Due to the above-mentioned limitations of the word/text processing tools, the user is forced to leave the application and use specialized software to solve the expressions and produce the numeric data and plots/tables, and copy the material back to the working document. The math tool claimed here solves this problem by automatically recognizing mathematical content in user input (even when embodied within regular textual description), verifying and evaluating mathematical expressions, and generating the numeric data/plots/tables all inside the word/text processing tool itself. This software will improve productivity and reduce errors in writing mathematical content inside electronic articles. The claimed invention differs from what currently exists. Existing spell checkers do not recognize mathematical expressions in user text for correctness and do not evaluate them. This software fills that void.

### SUMMARY

Embodiments of the present disclosure relate to a tool for recognition and evaluation of mathematical content within normal text. This tool automatically recognizes user input and identifies mathematical content (expressions including arithmetic and symbolic calculations, constants, variables, functions, operators, units, currencies, matrices, vectors, tables, plots and other mathematical notations) for the purpose of validating and evaluating the mathematical content in a seamless fashion without user intervention.

The embodiments herein may be carried out in conjunction with software code running on a processor, which causes the alteration of text content that was manually entered by a user or loaded from a file. It does this by first recognizing the mathematical content embedded inside the text, validating it by performing the actual mathematical computations, highlighting invalid expressions, and directly evaluating expressions (if needed). The processor running the software acts as the central hub for this activity, taking textual input and processing it according to the foregoing. The user of the computer or mobile device perceives the processed content visually through a display (preferably color display). Through use of an interface, such as a keyboard, a mouse or other similar devices, the user may enable and disable mathematical expression checks and evaluations, and reuse such checks and evaluations in subsequent expressions to ultimately verify the full technical content of a mathematical expression.

Once text including mathematical content is either entered or loaded from a file, the software causes a processor to automatically identify all mathematical content within the text and to validate it. Invalid expressions are identified and highlighted to the user. For example, they may be underlined in red and made visible to the user on a display such as a computer monitor or mobile device screen. Suggested answer(s) are provided to the user to correct the identified errors. The user can also configure this tool to define new constants, variables, equations, and functions as well as compose mathematical expression based on such definitions.

### BRIEF DESCRIPTION OF THE DRAWINGS

Particular embodiments will now be described, by way of example only, and with reference to the accompanying drawings:

FIG. 1 shows a block diagram illustrating device 2 (which may be a computer, mobile device such as a personal computer, tablet, etc.) connected to display 4.

FIG. 2 illustrates a top-level flow diagram showing different components of the math tool.

FIG. 3 illustrates a flow chart showing the operation of the math tool.

FIG. 4 illustrates a flowchart showing the math tool expression evaluation flow.

FIG. 5 shows a screenshot illustrating a display screen of an embodiment of the math tool inside MS Word™.

FIG. 6 shows a toolbar according to an embodiment of the math tool.

FIG. 7 shows an interface menu according to an embodiment of the toolbar shown in FIG. 6.

FIG. 8 shows a screenshot illustrating a display screen of an embodiment of the math tool inside MS PowerPoint™

### DETAILED DESCRIPTION OF EMBODIMENTS OF THE DISCLOSURE

Specific embodiments are described in detail with reference to the accompanying figures. Corresponding reference numerals and symbols are carried forward.

Embodiments of the present disclosure relate to a math tool (also referred herein throughout as “tool”) for recognition, evaluation and correction of mathematical content within normal text. This tool automatically recognizes user input and identifies mathematical content (expressions including constants, variables, functions, operators, units, currencies, matrices, vectors, tables, plots and other mathematical notations) for the purpose of validating and evaluating it in a seamless fashion without user intervention.

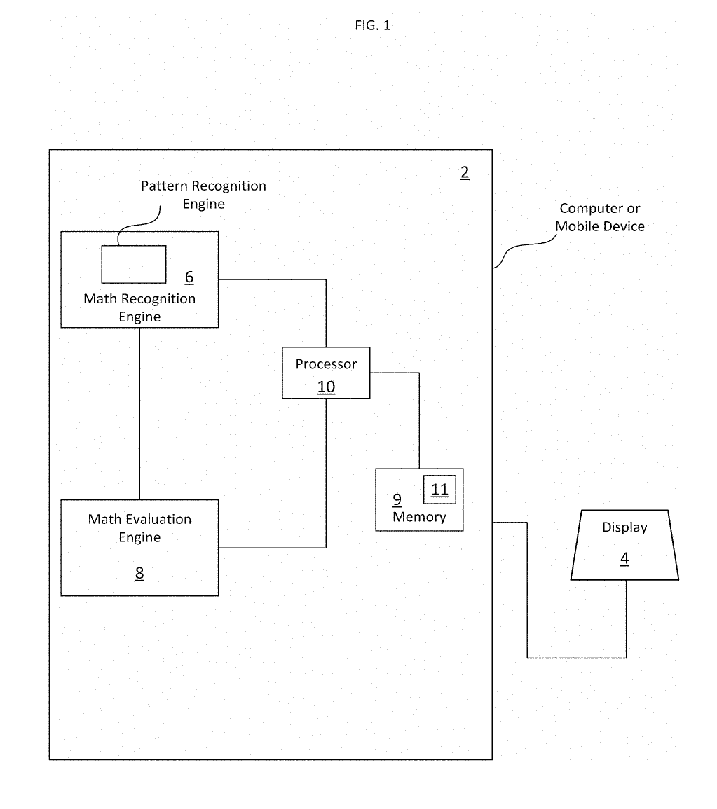

FIG. 1 shows a block diagram illustrating device 2 (which may be a computer, mobile device such as a personal computer, tablet, etc.) connected to display 4. The math evaluation tool as disclosed herein may be implemented with Math Recognition Engine 6 and Math Evaluation Engine 8, which may be implemented in hardware or software and connected to processor 10 within device 2.

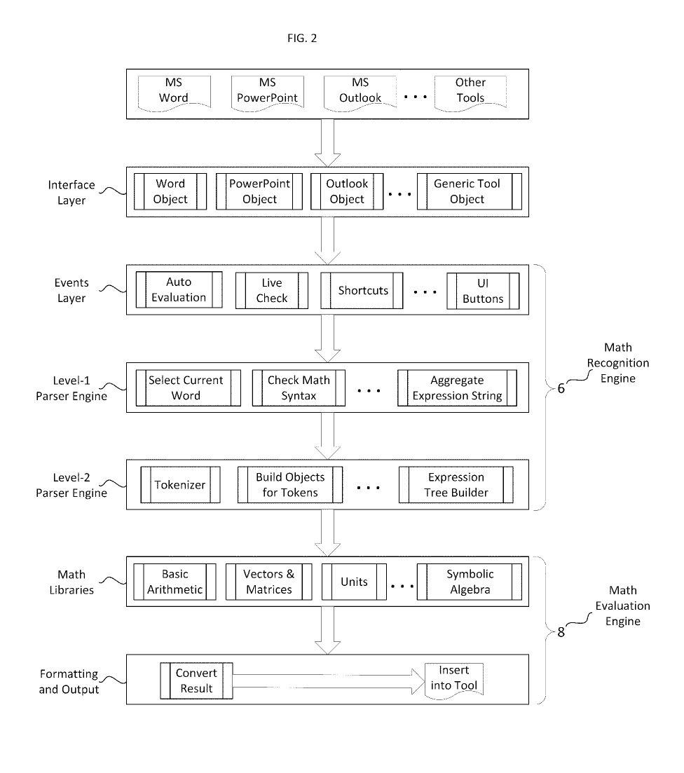

FIG. 2 illustrates a top-level flow diagram showing different components of the math tool as disclosed herein. The tool includes the following components as discussed below with reference to FIG. 2:
1. Input Sources
2. Interface Layer
3. Events Layer
4. Level-1 Parser Engine
5. Level-2 Parser Engine
6. Math Evaluation Engine
7. Formatting and Output Section

The term “engine” as used herein throughout refers to software, hardware or a combination of software or hardware for carrying out a particular function.

The tool disclosed herein may serve as an add-on application for standard text processing applications like MS Word™, MS PowerPoint™, MS Outlook™, web browser, chat or text messenger application, mobile or desktop operating system, etc., as shown in section 1 of FIG. 2. Alternatively, the tool may also serve as a stand-alone advanced mathematical processing tool.

The tool may take input in the form of standard text from standard text processing software (e.g., MS Word™, MS PowerPoint™, MS Outlook™, etc.) using the Interface Layer as shown in FIG. 2. Within the Interface Layer a respective object model/application program interface (API) (MS Word™ Object Model, MS PowerPoint™ Object Model, MS Outlook™ Object Model, etc.) is provided by the text processing software in order to read the user input. The standard text input does not necessarily have strong syntax (that is, syntax readily separating math expressions from normal text) in comparison with typical programming languages or specialized math tools.

FIG. 2 illustrates the functional elements of the math tool in conjunction with a basic process flow. The math tool's constituent parts may include an Interface Layer, an Events Layer, a Level-1 Parser Engine, a Level-2 Parser Engine, a Math Evaluation Engine, and a Formatting and Output Section.

The Events Layer of FIG. 2 monitors user input and automatically detects specific events for processing. For example, the software provides many in-built and user specified shortcuts, which can be used to quickly insert complex symbols and expressions using simple easy-to-type keyboard entries. The tool as disclosed herein also provides triggers on specific keyboard events (like typing “=”) to automatically evaluate and check expressions. The tool also provides triggers for context sensitive mouse events that when triggered provide mathematical suggestions/corrections to equations.

The Level-1 Parser Engine shown in FIG. 2 calls the specific application programming interface (API) of a given input source and extracts the associated text including required formatting such as super-script, sub-script, math formatting, etc. The formatted text is then converted to standard unformatted text and a math recognition algorithm is used to automatically recognize and extract math content from normal text. This is achieved by reading each symbol (referred to herein as a “word”) in the text.

The Level-2 parser shown in FIG. 2, the words (symbols) are tokenized. That is, the words, (symbols) are separated into pieces. As such, the Level-2 parser splits up a given valid math expression from the Level-1 parser into individual tokens. Thereafter, the symbols (words) are checked for conformance to standard mathematical syntax. For instance, mathematical elements such as +, =, −, etc. are classified according to the common understanding of their significance as mathematical operations and integers, fractions and the like are classified accordingly as numbers.

The tokens represent elements of the mathematical expression, such as numbers (unit-less or with units), variables, constants, vectors, functions, parentheses, measures, date-time, etc. The tokens are used to construct a mathematical expression based on the original expression and math syntax rules data held in memory 9 of FIG. 1.

In constructing a suggested/corrected mathematical expression, the tokenized elements are encapsulated (i.e., re-constructed according to math tool language and any embedded objects) and the resulting suggested/corrected expression is reduced in form in connection with evaluating the suggested/corrected expression. This reduced form may be arrived at through recursive evaluation of the suggested/corrected expression by the Math Tool Evaluation Engine. The Math Evaluation Engine, provides an abstraction layer for use with various mathematical libraries such as a basic arithmetic library, units library, complex numbers library, vectors library, matrices library, symbolic algebra library, currency library, date-time library, etc. Each library possesses its own syntax-related information enabling the Math Evaluation Engine to carry out the relevant operations. The Math Evaluation Engine solves the expression tree using the abstraction layer (e.g., one or more of the foregoing, discussed libraries) and it provides the result to the Formatting and Output section.

The Formatting and Output section converts the result transferred from the Math Evaluation Engine into a relevant format for display in a respective document and at an appropriate location. For instance, a resulting evaluated expression may appear on a display screen as a suggested replacement expression under or next to the original mathematical expression.

The Formatting and Output section functionality may be accomplished through use of software, hardware or a combination of software and hardware.

### Math Recognition Engine:

With reference to FIG. 2, Math Recognition Engine 6 operates to extract mathematical expressions from standard text, without the need for any special syntax to separate the math content from the text. Math Recognition Engine 6 may include the following:
1. User configurable tables for operators, variables, constants, functions, key symbols (like parentheses and brackets, argument separators and other key words), structures for advanced operators like integrals and differentials, units, currency symbols/codes, etc.;
2. Grammar rules for defining various functions;
3. A Level-1 Parser Engine to convert formatted text to normal text. This component is necessary to convert natural language format of the expression to a simple text, which includes proper operators. For example, superscript will represent power operator as in x^{y} gets translated to x̂y, a fractional representation like

$$\frac{a}{b}$$

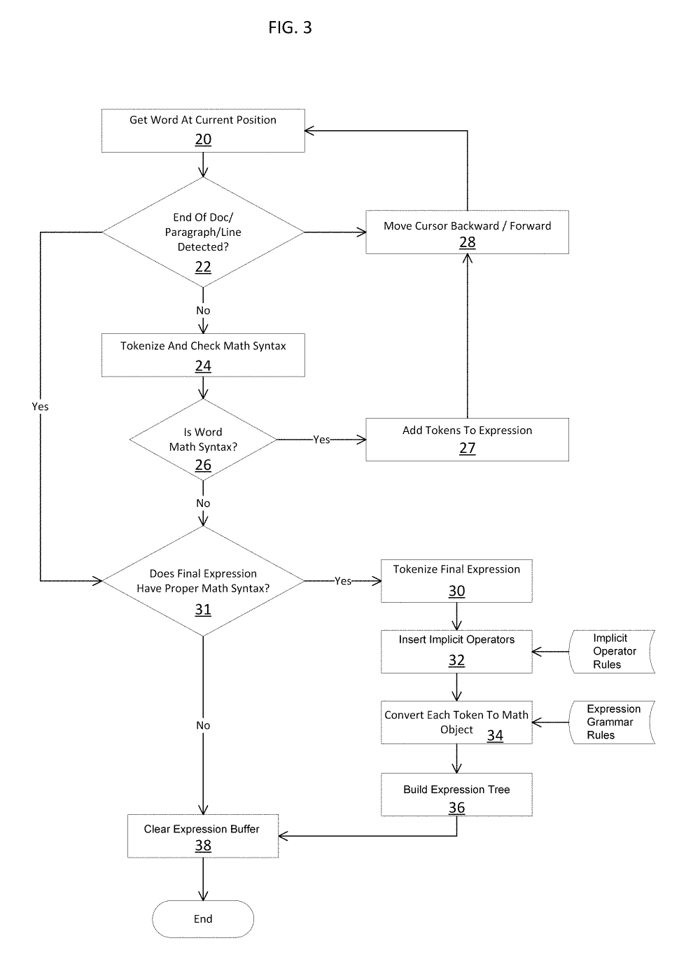

gets translated to a/b with proper division operator, etc.;
4. A Level-2 Parser Engine with a Tokenizer that acts to convert an expression string into a list of tokens, wherein each token represents the elements of the hash tables, specific math objects (i.e., math functions), etc.; and
5. A Pattern Recognition Engine in 6 within 2 of FIG. 1 for detecting whether the list of tokens partially or entirely comprise math syntax. Accordingly, the Pattern Recognition Engine operates to aggregate and/or separate the tokens to form one or multiple math expressions. This includes smart detection and identification of separators like “comma,” “colon,” “symbol,” etc., to be part of the same expression or part of non-math text separating two expressions. This gives a superior capability over and above what is found in other math tools wherein a mathematical expression can be directly embedded in documents and be part of standard text body without any specific pre-determined syntax or object to separate standard text from math expressions. Math Recognition Engine 6 identifies the expression correctly, providing for the performance of various operations on the mathematical expression by the Math Evaluation Engine 6 as disclosed herein.
   FIG. 3 illustrates a flow chart showing the operation of the math tool as described herein. At step 20, a word is identified/selected from its position within a document. “Word” and “Words,” respectively, as used herein refer to one or more symbol groupings recognized as conveying useful information. A decision is made when predefined expressions separators/end of line/end of paragraph or end of document for detection. If such are detected, the next word in the document is processed. This may be signaled by the movement of a cursor (not shown) on display 4 (FIG. 1) ahead to the next “word” for processing as indicated at step 28. Should no such end detection be made, the “word” is “tokenized” according to specific math patterns at step 24. At decision step 26, a determination is made as to whether a tokenized word connotes that which is consistent with math syntax. If math syntax is detected, the word is added to an expression in a buffer 11 within memory 9 (FIG. 1) at step 27. Should math syntax not be detected, the entire expression string of words (which comprises a mathematical expression in buffer 11) is checked for proper math syntax at step 31. Should math syntax not be detected, the expression buffer 11 within memory 9 (FIG. 1) is cleared at step 38, and the process terminates. If math syntax is detected, the expression is again tokenized at step 30, in preparation for Math Engine Evaluation after the Level-2 Parser Engine as shown in FIG. 2. Implicit operators associated with the tokenized expression are inserted according to implicit operator rules, into the expression string at step 32. Using expression grammar rules, each token is converted at step 34 to an object (consistent with object-oriented programming) for use with the math tool. At step 36, the final mathematical expression tree is constructed, and is ready for evaluation. The expression buffer is cleared at step 38 and the process terminates.

### Math Evaluation Engine:

With reference to FIG. 2, the Math Evaluation Engine 8 evaluates various forms of mathematical expressions such as standard basic arithmetic, pre-defined or user-defined functions, variables, constants, vector/matric algebra, units conversions and expressions, currency conversions, symbolic algebra, etc. The Math Evaluation Engine may include the following:
1. A Classification Engine, which intelligently classifies the expression into possible valid types, such as a simple arithmetic expression, an expression with units and measurables, symbolic expressions, and expressions with vectors and matrices, etc. The Classification Engine then applies the correct operator/function based on the context. This aspect of the Classification Engine makes the math tool user friendly and universal, wherein the user need not specifically define the data type, nor the math tool needs to have multiple user interface (UI) elements to evaluate various expression types;
2. An Object Wrapper to define operations and functions for multiple expression types, and to provide the final result in a consistent manner;
3. A Math Computation Engine that operates on an expression and performs the necessary operations in the desired order to arrive at a correct result; and
4. A Formatting and Output Section to take the result of the evaluation in the previous step and apply proper formatting that includes notation, precision and numerical formatting requirements specified by a user; text and color formatting specified by a user; formatting of vectors and matrices for display; and formatting plots and tables according to user specifications, etc.

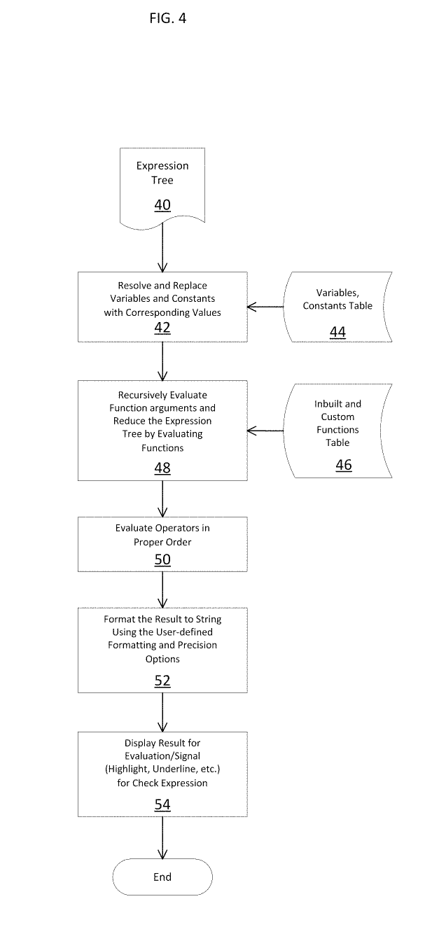

FIG. 4 shows a flowchart illustrating the math tool expression evaluation flow. With reference to FIG. 4 from expression tree in step 40, encapsulation of the “words” begins at step 42 with resolving and replacing variables and constants with corresponding values from a variables and constants table 44. Using an in-built custom functions table 46, the function arguments in the encapsulated expression are recursively evaluated and reduced by evaluating the functions at step 48. At step 50 the operators in the expression are evaluated in proper order. At step 52, the resulting expression string from step 50 is formatted using user defined formatting, notation, and precision options. At step 54, the resulting correct expression is displayed upon display 4 along with the signaling of an indication, such as an invitation to the user to check the resulting correct expression. Such indication can be provided by highlighting, underlining, etc., the expression.

### Modes of Operation:

The above Math Recognition and Evaluation Engines may operate in several modes as detailed below:
1. In Live Mode, the engines automatically recognize user input and, detect when math expressions are entered and automatically evaluate them. In this mode, the equal sign (“=”) acts as a trigger to cause the evaluation engine to automatically evaluate the expression and place the computed result right after the equal sign. If an expression is provided with units, the evaluation engine gives the value according to the units provided. If the user types in a wrong expression, the tool automatically underlines it as an indicator to the user to correct it.
2. In Manual Mode, the evaluation engine attempts to evaluate/check the current selection or detects the range of the expression where the cursor is located by user either clicking the ribbon evaluate button or its corresponding keyboard shortcut.
3. The evaluation engine also has an evaluate selection, check selection, evaluate page, check page, evaluate-all, and check-all functionalities which are meant for opened documents with existing expressions. The evaluation engine then parses the selection/page/or full document, recognizes mathematical expressions and attempts to evaluate/check them.
4. The evaluation engine may cause a context sensitive menu, to appear on display 4 with a right-click option for a keyboard/mouse (not shown) along with suggestions for math equations; evaluation results of expressions which are not evaluated; correction of results for wrong expressions; correction of possible parenthesis mismatch; or other math checks.

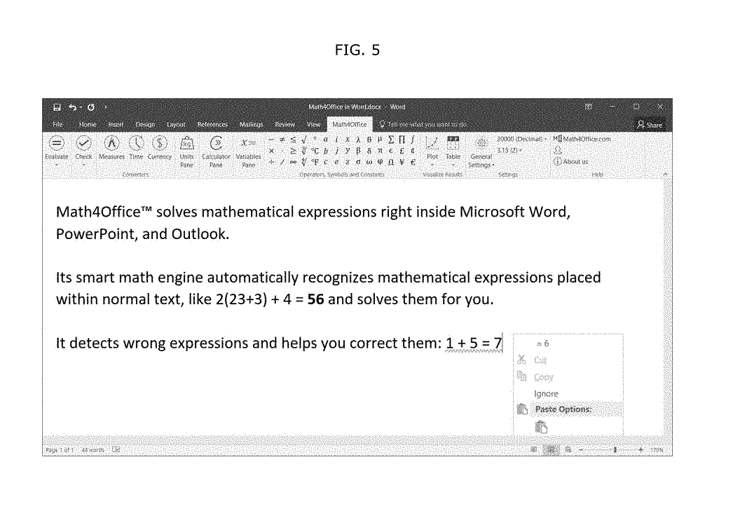

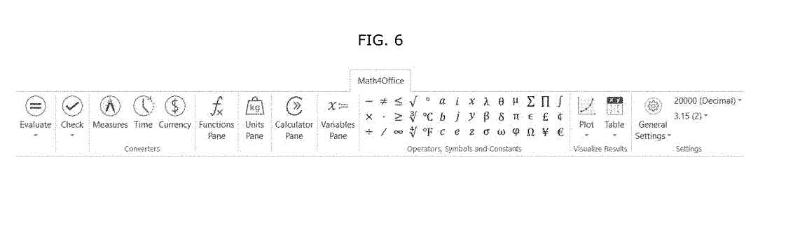

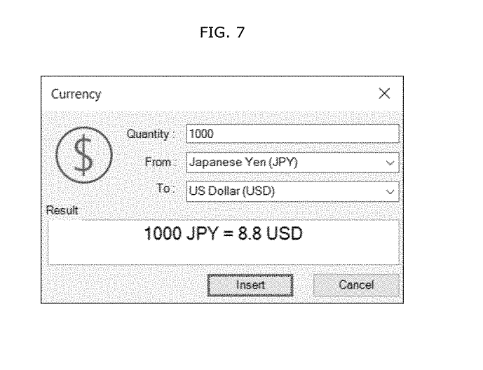

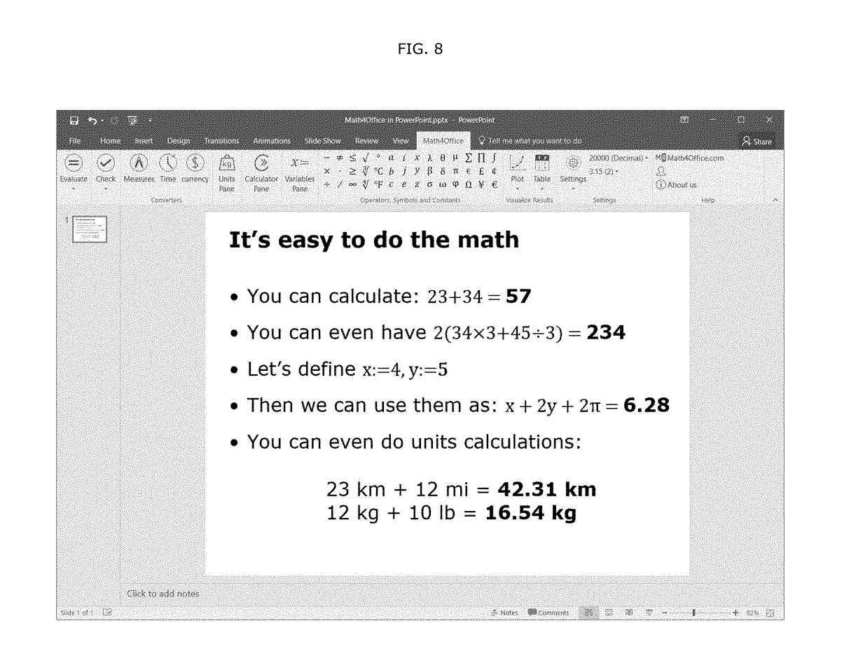

FIG. 5 illustrates a screenshot of a display layout according to one embodiment of the math tool inside MS Word™. Several custom buttons are illustrated such as Evaluate, Check, Measures, Time, Currency Converters, Functions Pane, Units Pane, Calculator Pane, Operators, Symbols, and Constants, Variables Pane, and Plot and Table menus. FIG. 6 illustrates a close-up of a toolbar shown in the screenshot of FIG. 5. Each button may activate a pull down/pop out menu allowing functionality regarding a function activated by the named button. For instance, the currency function pane may show currency conversion from one denomination to another such as conversion from Japanese Yen to U.S. dollars as shown in the pop out menu of FIG. 7. FIG. 8 shows another example of the math tool integration into MS PowerPoint™.

### Plots and Tables

The math tool herein may also be used to generate table and plot drawings/graphs in connection with mathematical expression evaluations as described herein. For instance, should a native application, in which math syntax text is/has been entered and mathematical functions/numerical data generated, the math tool may provide functionalities to present this information in the form of tables and plots. Such plots are contemplated as pie charts, bar graphs, three-dimensional plots of a function in two variables, a line plot with multiple data vectors versus an independent variable, single data points on an xy-coordinates graph, and the like. Such tables are contemplated as row or column listings of the numerical data resulting from the mathematical calculations. Towards this functionality, it is further contemplated that the math tool as disclosed herein may detect specialized commands, in a native application, for displaying data or symbolic functions. It is further contemplated that the math tool may detect specialized commands in a native application for formatting a given matrix or vector data into tables and inserting a plot or table after an associated command has been entered by a user.

### EXAMPLES

(A) Within document text, given that mathematical syntax is identified or given that a mathematic expression is entered in a document, such as “2³=8”, the expression is encapsulated according to the format of the math tool. In one embodiment, this encapsulation may result in the expression being notated as “2̂3=8” with the ̂ symbol depicting a raised power symbol signifying that the number 2 is to be raised to the third power. Tokenizing the foregoing expression, yields five tokens: namely, 2, ̂, 3, = and 8. The tokens are assigned consecutive token numbers as they are created and in conjunction syntax rules and the token number order, a second mathematical expression is created according to the syntax of the math tool which in this example is “2̂3=8”.

(B) Should a variable, X, be defined as 4 and a variable Y be defined as 5, then an expression, either inputted into a document or detected in a document reflecting X+2Y=15 will be highlighted by the math tool and a corrected expression can be offered. As such, 14 will be shown on display 4 of FIG. 1 as a choice to replace the 15 originally indicated.

(C) Complex expressions for evaluation can be evaluated by the math tool. For instance, expressions such as (3+5*2+(10+30/2)/4)/10=1.93 can be correctly evaluated along with application of standard math rules for evaluation. The various embodiments described herein are provided by way of example only and should not be construed in a limiting sense to limit the scope of the disclosure.

### Tutoring Tool

In some embodiments, in addition to providing a suggestion for correction of perceived errors in a mathematical expression, the math tool may provide suggestions as to possible results for evaluation of a mathematical expression along with a teaching of the math syntax rules involved. For instance, should a parenthesis be missing in an expression, a pop-up or other indicia may be displayed in a document, according to mechanisms described herein for displaying other expression suggestions, noting that “parenthesis must come in pairs.” Further, choices for selection may be displayed showing resulting expressions as determined by likely insertion positions in a suggested corrected mathematical expression.

Those of ordinary skill in the art will readily recognize various modifications and changes that may be made to the principles described herein without following the example embodiments and applications illustrated and described herein, and without departing from the spirit and scope of the disclosure.

We claim:

1. A system for automatically recognizing math content embedded within regular text and figures, evaluating mathematical expressions and correcting one or more errors, comprising:
a graphical user interface for input of text and data in a native format into a document;
a processor configured to process and evaluate mathematical formulae;
a memory for storing one or more mathematical expressions;
a first level parser engine operable to encapsulate a mathematical expression;
a second level parser engine operable to tokenize a mathematical expression; and
programmable, non-transient, code for causing the processor to detect and evaluate mathematical expressions in conjunction with the first level parser engine and second level parser engine.

2. A system as recited in claim 1 further including a recognition engine, said math recognition engine including multi-level word parsers, expression tokenizers, and full expression builders, for use in recognizing valid mathematical expressions embedded in text.

3. A system as recited in claim 1 further including an evaluation engine, said math evaluation engine including one or more libraries held in said memory for use in evaluating a mathematical expression after being recognized as recited in claim 2.

4. A system as recited in claim 3 wherein said libraries consist of a basic arithmetic library, a units library, a currencies library, a symbolic math library, a vector/matrix library, and a combination thereof.

5. A system as recited in claim 4 further including a formatting and output section within said evaluation engine for formatting said mathematical expression evaluated by said evaluation engine in conjunction with said processor, and formatting and inserting a mathematical expression into the document in the native format and user-defined notation and numerical precision.

6. A method for evaluating a mathematical expression and correcting one or more errors, comprising:
scanning a document, in a native format, symbol by symbol, for mathematical syntax;
identifying mathematical syntax, in connection with the scanning of the document, using a processor;
encapsulating each symbol, using the processor, identified as mathematical syntax;
assigning a token value and token number to each symbol as forming a second mathematical expression in conjunction with arranging each token value according to a token number in conjunction with mathematical syntax rules;
evaluating the second mathematical expression;
transforming, using the processor, the second mathematical expression to a native format mathematical expression without errors.

7. A method as recited in claim 6 wherein said mathematical syntax consists of arithmetic operators, mathematical functions, user-defined variables, constant numbers, units, data and/or time designations, currencies, vector and matrix algebra, symbol algebra or a combination thereof.

8. A method as recited in claim 6 wherein said method is implemented in connection with a user entering a mathematical expression into a document.

9. A method as recited in claim 8 wherein the mathematical expression is evaluated asynchronously such that it does not block input by a user entering information and such that the mathematical expression is evaluated in the background in conjunction with evaluation of the mathematical expression and correction of errors.

10. A method as recited in claim 6 wherein said method is implemented after a mathematical expression has been entered into a document.

11. A method as recited in claim 6 which further includes detecting of specialized commands, in a native application, for plotting of data or symbolic functions into tables.

12. A method as recited in claim 11 wherein plotting of data or symbolic functions includes plotting of a bar graph, pie chart, three-dimensional plot of a function of two variables, single data points on an xy-coordinates graph, and the like.

13. A method as recited in claim 6, further comprising displaying, on a monitor, at least one suggested correction for a mathematical expression along with mathematical convention rules governing one or more aspects of the mathematical expression.

14. A module for evaluating a mathematical expression and correcting one or more errors, comprising
a first level parser engine operable to encapsulate a mathematical expression;
a second level parser engine operable to tokenize a mathematical expression;
programmable, non-transient code for causing a processor to detect and evaluate mathematical formula in conjunction with the first level parser engine and the second level parser engine.

15. A module as recited in claim 14 wherein said module is an Internet application that is accessible with an Internet browser.

16. A module as recited in claim 14 wherein said module is an application operable on a desktop or mobile platform.

17. A non-transient computer readable storage media comprising code for causing a processor to do the following:
scan text, symbol by symbol, for mathematical syntax;
identify mathematical syntax;
encapsulate each symbol within identified mathematical syntax identified within the text;
assign a token value and a token number to each symbol;
form a second mathematical expression in conjunction with arranging each token value according to a token number in conjunction with mathematical syntax rules;
evaluate the second mathematical expression; and
transform the second mathematical expression to a native format mathematical expression without errors.

18. A system as recited in claim 4 further including a set of converters for converting between units, between measures, between currencies, and time between cities/countries/international time zones by said evaluation engine in conjunction with said processor, and formatting and inserting a mathematical expression into the document in the native format and user-defined notation and numerical precision.
